(19) United States
(12) Patent Application Publication
(10) Pub. No.: US 2004/0256169 A1
(43) Pub. Date: Dec. 23, 2004

(54) Vehicular crash life guard system

(76) Inventors: Peter Nicholas Budzilovich, Nyack, NY (US); Vladimir Kostrikov, Sea Cliff, NY (US)

Correspondence Address: Peter N. Budzilovich, 62 Washington St, Nyack, NY, 10960-3730, US

(21) Appl. No.: 10/465,828

(22) Filed: Jun. 20, 2003

(51) Int. Cl. B60T 7/12; B60T 7/22

(52) U.S. Cl. 180/277

(57) ABSTRACT

Provided is a Vehicular Crash Life Guard System (referred to hereinafter as “VCLGS”) for:

1. Preventing fires in vehicles by automatically disconnecting vehicle power sources, including batteries and generators or alternators, from the vehicle's electrical wiring during emergencies, such as crashes.

2. Preventing vehicle theft by permitting the operator to disable or enable the vehicle's electrical system at his discretion.

3. Preventing battery discharge when a vehicle is left unattended by disconnecting the battery of vehicle.

4. Preventing self-ignited fires due to electrical short-circuits in unattended vehicles.

While the VCLGS is particularly useful in passenger cars equipped with air bags that, upon deployment, often render the driver unconscious, it can be just as useful in any other vehicle.

### FIELD OF THE INVENTION

This invention relates generally to automotive safety. In a more specific aspect, it relates to the prevention of vehicular fires due to sparks caused by short-circuits in vehicular wiring that occur during vehicular crashes.

### BACKGROUND OF THE INVENTION

Each year, several thousands of people perish in vehicular fires that occur after a vehicle crashes. According to the Fatality Analysis Reporting System (FARS), in 2001, there were fire occurrences in 1,448 fatal crashes involving 1,657 vehicles and 2,619 persons. Of course, there are many more non-fatal vehicular fires due to crash-caused short-circuits within vehicle's electrical wiring that result in a loss of property. Furthermore, vehicular fires due to short-circuits within vehicle's electrical wiring are known to occur in non-crash cases, even in vehicles left unattended. In a typical vehicle, there are numerous wires that remain energized at all times, regardless of whether or not the ignition of the vehicle is turned ON. A short-circuit from any of these wires may cause an electric spark or a “hot spot,” that, in turn, may ignite vehicle's fuel or other flammable material and trigger a fire. If there were means to disconnect electric power sources (e.g. battery and generator or alternator) from the vehicle's wiring when a vehicle crashes, chances of such fires could be greatly reduced. In fact, the first thing that fire fighters and/or police do, upon arrival at a scene of an accident, is to cut the wires at the battery terminal of the vehicle.

### DESCRIPTION OF THE DRAWING

FIG. 1 is a schematic of a preferred embodiment of a Vehicular Crash Life Guard System.

### THE DESCRIPTION OF THE PREFERRED EMBODIMENT

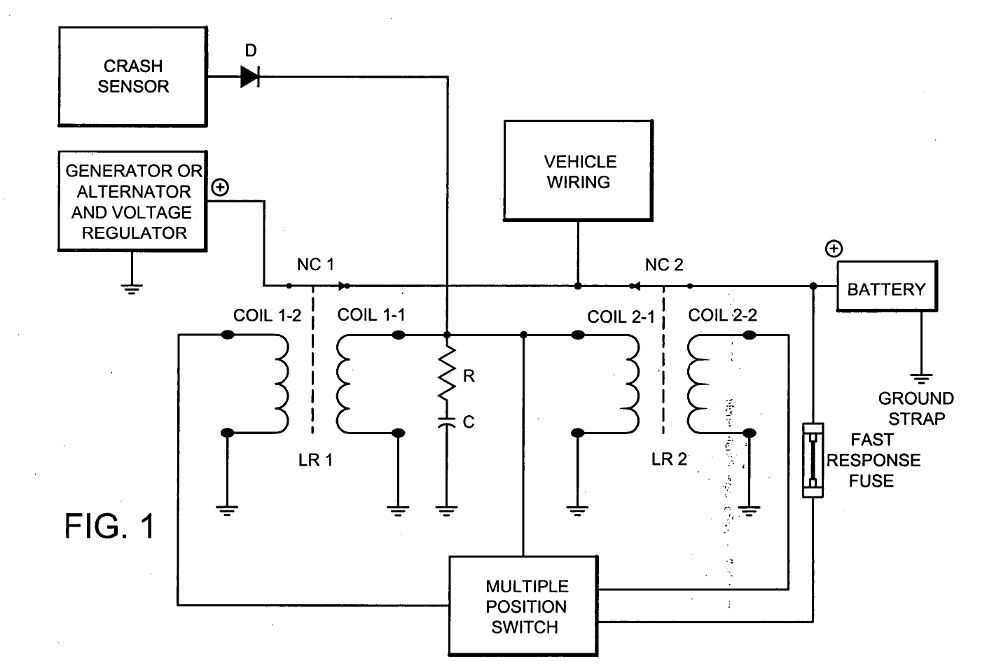

FIG. 1 depicts a generalized version of a VCLGS consisting of as many normally ON latching relays (LR) as there are power sources and a multiple-position switch (SW). In the simplest case, there may be two LRs—one located at the prime vehicle power source (battery), LR 2, and the other at the generator or alternator, LR 1. The switch may be a pushbutton, a toggle, or some other kind. The main-power-source relay, LR-2, must be equipped with normally-closed contacts, NC 2, capable of handling all electrical loads in a vehicle (including starter). Physically, it is placed as close to the main power source as feasible (ideally—right on the battery's terminal), to ensure that no wires remain energized after the LR 2 operates in response to a crash-related signal or the SW. The LR-1 controlling the secondary power sources (e.g. generator or alternator) is equipped with lesser capacity contacts and is located as closely as possible to the secondary power source. Once the contacts of LRs are opened, all electrical power (except to the VCLGS switch, SW) is removed from the vehicle's wiring, even if the generator might be turning and producing an output. The LRs' coils 1-1 and 2-1 might be actuated either by some crash-related signal coming from a crash sensor in vehicles equipped with airbags, or from some other crash-sensing device, or by the SW. A diode isolates crash sensors from the SW. In either case, LRs' contacts NC 1-1 and NC 2-1 open and disconnect all electric power sources from the wiring of the vehicle. They will remain open until an operator uses the SW to actuate coils 1-2 and 2-2 to return the LRs to their normally ON state. In those cases where there are no existing crash sensors in a vehicle, a suitable crash sensor (or sensors) may be installed and connected to the VCLGS. Physically, the LRs must be placed as closely as possible to the electric power sources they are supposed to disconnect. The SW should be conveniently accessible to the operator of the vehicle. A fast-response fuse in the SW circuit, located as closely as possible to the prime power source of the vehicle, ensures that a short circuit in the SW circuit removes electric power from the wire between the battery and the SW. In vehicles equipped with air bags, the VCLGS also includes a delay network that includes a resistor R and a capacitor C for delaying the LR operation for approximately 0.1 of a second to permit the proper deployment of airbags and possible other safety systems prior to removing electric power from the vehicle's wiring.

In more elaborate VCLGSs (e.g., for increased safety), LRs may be employed to disconnect the power sources at both the positive (“plus”) and the negative (“minus”) terminals, the “ground strap.”

While in the above description electromechanical relays have been used to demonstrate the VCLGS principle of operation, solid-state switches may be used to accomplish the same purpose.

THE VCLGS MIGHT BE OPERATED IN AT LEAST TWO MODES AS FOLLOWS:

1. Crash-related fire prevention.

2. Non-crash fire, or theft, or battery discharge prevention.

In the crash-related fire-prevention mode, a signal obtained from some vehicle's crash-related device, such as a crash sensor, actuates coils 1-1 and 2-1 of the LRs (after a suitable delay in vehicles equipped with airbags to permit their deployment). LRs' contacts remain open until operated closed manually by the SW or some other means by actuating coils 1-2 and 2-2 of the LR 1 and LR 2, respectively.

In the non-crash fire, or theft, or battery discharge prevention mode, the LRs are actuated manually by the SW. Once the LRs operate, the vehicle cannot be started since all electric power (except to the SW) is removed from the vehicle's wiring. To enhance the VCLGS' theft-prevention capability, the SW may be equipped with either a key or some other locking device.

What is claimed is:

1. An apparatus for a Vehicular Crash Life Guard (VCLGS), comprising means for disconnecting and connecting vehicular electrical power sources (including battery and a generator or an alternator) from the vehicle's wiring. The VCLGS can be installed either at the factory by vehicle manufacturer, or by users in existing vehicles, with or without air bags.

2. In a VCLGS, a latching relay (referred to hereinafter as “LR”) for disconnecting vehicular prime power source such as battery from all vehicle's wiring.

3. In a VCLGS, a latching relay (referred to hereinafter as “LR”) for disconnecting vehicular secondary power sources such as a generator or alternator from the vehicle's wiring.

4. In a VCLGS, a multi-position switch (pushbutton or other type, referred to hereinafter as “SW”) permitting an operator to turn the vehicle's LRs either ON or OFF.

5. In a VCLGS, the ability to disconnect vehicular electric power sources from the vehicle's wiring system in response to a crash-related signal or to operating the SW.

6. In a VCLGS, the ability of the system to operate with any vehicle using any propulsion means, including gasoline, diesel, electric, natural gas, or any other kind.

7. In a VCLGS, a network for delaying the operation of the LRs in response to a crash-related signal in vehicles equipped with airbags to provide sufficient time for the airbags to open before disconnecting all electrical power from the vehicle's wiring.

8. In a VCLGS, a fast-response fuse connecting the prime power source terminal (such as battery) to the SW. Such a fuse should be located as close to the prime power source terminal as possible.
